(19) United States
(12) Patent Application Publication
(10) Pub. No.: US 2025/0386255 A1
(43) Pub. Date: Dec. 18, 2025

(54) SYSTEM, METHOD, USER EQUIPMENT AND BASE STATION FOR PERFORMING A HANDOVER IN A WIRELESS NETWORK

(71) Applicant: Continental Automotive Technologies GmbH, Hannover (DE)

(72) Inventors: Andreas Andrae, Frankfurt am Main (DE); Rikin Shah, Langen (DE); David Gonzalez Gonzalez, Egelsbach (DE)

(73) Assignee: Continental Automotive Technologies GmbH, Hannover (DE)

(21) Appl. No.: 18/878,703

(22) PCT Filed: Jun. 20, 2023
(86) PCT No.: PCT/EP2023/066631

§ 371 Date: Dec. 24, 2024

(30) Foreign Application Priority Data
Jun. 24, 2022 (DE) 10 2022 206 394.5

(51) Int. Cl. H04W 36/00; H04W 74/0833

(52) U.S. Cl. CPC H04W 36/0077; H04W 74/0833

(57) ABSTRACT

A handover is performed of a user equipment from a first base station to a second base station in a wireless network. The user equipment performs random access to the second base station using a Random Access CHannel occasion from a subset selected from a set of Random Access CHannel occasions according to a Quality Of Service (Qos) profile assigned to the user equipment. A user equipment and a base station and a system implement corresponding methods.

### CROSS-REFERENCE TO RELATED APPLICATIONS

The present application is a National Stage Application under 35 U.S.C. § 371 of International Patent Application No. PCT/EP2023/066631 filed on Jun. 20, 2023, and claims priority from German Patent Application No. 10 2022 206 394.5 filed on Jun. 24, 2022, in the German Patent and Trademark Office, the disclosures of which are herein incorporated by reference in their entireties.

### TECHNICAL FIELD

The following relates generally to wireless communications, and more particularly to a method of improved handover in non-terrestrial networks as well as integrated terrestrial and non-terrestrial networks.

### BACKGROUND

Wireless communication systems are widely deployed to provide various types of communication content such as voice, video, packet data, messaging, broadcast, and so on.

A wireless multiple-access communication system may include a number of base stations, each supporting communication for multiple mobile devices simultaneously. A base station may communicate with User Equipments (UEs) on downstream and upstream links. Each base station has a coverage range, sometimes referred to as a cell coverage area.

Non-Terrestrial Networks (NTN) has become an umbrella term for any network that involves non-terrestrial flying objects, like satellites communication networks or High-Altitude Platforms Systems (HAPS) including airplanes, balloons and airships.

Satellite communication networks rely on spaceborne platforms comprising Low Earth orbiting (LEO) satellites, Medium Earth Orbiting (MEO) satellites, and geosynchronous Earth orbiting (GEO) satellites.

Nowadays, there is a growing interest in the broadband services supported by LEO NTNs, with large satellites constellations, because of its advantages in smaller propagation delay and higher link quality than MEO or GEO satellites. The satellite industry is now committed in the 3GPP process to integrate satellite networks into the 5G ecosystem.

The integration of Non-Terrestrial Networks (NTNs) within the 5G framework is under standardization and can lead to manifold advantages, such as wide service coverage capabilities, reduced vulnerability of space/airborne vehicles to physical attacks and natural disasters, or reinforced service reliability.

However, NTN integration is also leading to challenges related to the employment and adaptation to aerospace networks of technologies originally designed for terrestrial networks.

In particular, handover in LEO satellite networks differs significantly from the traditional terrestrial cellular networks in that the handover is triggered by the mobility of the satellite. In terrestrial networks, there are relatively small, fixed cells and moving UEs, whereas in non-terrestrial networks, cells are moving along with satellites movements. In comparison, UE movements are slow and sometimes negligible. Once the LEO satellite moves to a new cell, most (if not all) of the UEs will be handed over to another cell.

Considering the large cell size of non-terrestrial networks, many devices may be served within a single cell. Depending on constellation assumptions (e.g., propagation delay and satellite speed) and UE density, a potentially very large number of UEs may need to perform handover at a given time, leading to possibly large signaling overhead and high-power consumption, as well as service continuity challenges. Moreover, if many UEs need to be handed over from one base station to another, then random access collisions would increase among UEs.

There is therefore a need for a method of handover that reduce random access collisions and UE energy consumption.

### BRIEF SUMMARY

According to a first aspect of the present disclosure, it is provided a method of wireless communication by a user equipment for supporting a handover of said user equipment from a first base station to a second base station in a wireless network, wherein said user equipment performs random access to said second base station using a Random Access CHannel (RACH) occasion from a subset selected from a set of Random Access CHannel occasions according to a Quality Of Service (QOS) profile assigned to said user equipment.

RACH slots and/or RACH occasions available for a particular user equipment thus depends on a Quality of Service (QOS) profile of said user equipment. Therefore, the risk of contention while performing a Random Access Procedure during a handover of a set of UE from a first base station to a second base station is reduced, as UE with different QoS profile will use different RACH slots.

According to an embodiment, said Random Access CHannel occasion used to perform random access is selected by said user equipment from a mapping between Random Access CHannel occasions and QoS profiles.

User equipment is provided with a mapping table in which RACH slots and/or RACH occasions are associated with QoS profiles. UE may therefore use this mapping to select RACH occasions available to establish uplink channel to a second base station on the basis of its QoS profile.

According to an embodiment, said mapping between Random Access CHannel occasions and Quality of Service profiles is preconfigured in said user equipment.

It is thus contemplated that the associations between QoS values and RACH slots/occasions are statically configured in a memory of the user equipment instead of being transmitted in a signaling message. Such a provision makes it possible to save signaling resources by avoiding the transmission of the mapping table.

According to an embodiment, said subset of Random Access CHannel occasion selected from a set of Random Access CHannel occasions according to a Quality of Service parameter associated with said UE is received in a handover command message sent by said first base station.

The base station selects RACH occasions and/or RACH slots available for a particular user equipment to perform RACH on a second base station on the basis of a QoS profile of said user equipment. Thus, only RACH occasions and/or RACH slots that correspond to a QoS profile of a UE are received by said UE. Such a provision allows a dynamic configuration of the mapping between QoS and RACH occasions while saving bandwidth.

Another aspect of the disclosure relates to a wireless communication apparatus for supporting a handover of a user equipment from a first base station to a second base station in a wireless network, said apparatus comprising a processor coupled with a memory in which computer program instructions are stored, said instructions being arranged to implement a method of wireless communication for supporting a handover by a user equipment wherein said user equipment performs random access to said second base station using a Random Access CHannel (RACH) occasion selected from a set of Random Access CHannel occasions according to a Quality of Service (QOS) profile assigned to said user equipment.

The disclosure also relates to a user equipment comprising a wireless communication apparatus for supporting a handover of a user equipment from a first base station to a second base station in a wireless network as described hereinabove.

According to a further aspect, the disclosure relates to method of wireless communication by a second base station for performing a handover of a user equipment from a first base station to a second base station in a wireless network, the method comprising the following acts:
Obtaining a set of Random Access Channel occasions available for performing Random Access to said second base station,
Obtaining a Quality of Service profile assigned to said user equipment,
Selecting a specific subset of Random Access Channel occasions from said set of Random Access CHannel occasions obtained, said subset being selected according to at least said Quality Of Service (QOS) assigned to said user equipment,
Transmitting to the first base station, a message comprising said selected subset of random access channel occasions,
Receiving a Random Access Request from a user equipment associated with a particular QoS value, said Random Access Request being received on a RACH occasion associated with said user equipment QoS value in the determined mapping table.

Instead of simply sending a set of available RACH slots/occasions in response to a handover request, the target base station sends a subset of RACH occasions that is selected according a QoS profile associated with the UE to handover. Such a provision makes it possible for the target base station to spread out RACH procedures in the time and frequency domain, therefore limiting the risk of RAHC contentions.

In an embodiment, the Quality Of Service assigned to user equipment is obtained in a handover request message.

When requesting a handover to a target base station, the source base station includes a quality of service profile assigned to the UE to handover. The target base station is thus aware of the QoS associated with that UE and may selected particular RACH occasions of a particular number of RACH occasions depending on said QoS profile.

It is also contemplated a wireless communication apparatus for performing a handover of a user equipment from a first base station to a second base station in a wireless network, said apparatus comprising a processor coupled with a memory in which computer program instructions are stored, said instructions being arranged to implement a method of wireless communication described hereinabove, and a base station device comprising such apparatus.

Another aspect of the disclosure relates to a wireless communication system for performing a handover of a user equipment from a first base station to a second base station in a wireless network, wherein said user equipment performs random access to said second base station using a Random Access CHannel occasion from a subset selected from a set of Random Access CHannel occasions according to a Quality of Service (QOS) profile assigned to said user equipment, and wherein said second base station receives a Random Access Request on a Random Access Channel occasion selected.

According to an embodiment, said selected Random Access Channel occasion is selected by said second base station and wherein said Quality of Service profile assigned to said user equipment is received from said first base station in a handover request message.

According to an embodiment, said selected Random Access Channel occasion is selected by said first base station from a set of Random Access Channel occasions received from said second base station in a handover acknowledgment message, and wherein said selected Random Access Channel occasion is sent to said user equipment in a RRC Reconfiguration message.

In a particular embodiment, the various steps of the wireless communication method for supporting a handover by a user equipment and the wireless communication method for performing a handover by a base station are determined by instructions of computer programs.

Consequently, the disclosure further contemplates computer programs on an information medium, these programs being suitable to be implemented respectively in user equipment device and a base station, or more generally in a computer, these programs respectively comprising instructions adapted to implement the steps of the wireless communication methods respectively supported by a user equipment and performed by a base station which have just been described.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove.

The information medium may be any entity or device capable of storing the program. For example, the medium can comprise a storage means, such as a ROM, for example a CD ROM or a microelectronic circuit ROM, EEPROM, FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may in particular be downloaded from a network.

Alternatively, the information medium may be an integrated circuit into which the program is incorporated, the circuit being arranged to execute or to be used in the execution of the methods in question.

The advantages of the user equipment, the base station, the system, of the corresponding computer programs and information mediums are identical to those presented in relation with the corresponding method according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1 illustrates an environment adapted to implement the methods disclosed herein.

FIG. 2 is a combined flow chart and block diagram showing a state-of-the-art handover procedure.

FIG. 3 illustrates a particular Random Access resources configuration.

FIG. 4 is a flow chart depicting mains steps of methods of wireless communication for supporting and performing a handover, according to an embodiment.

FIG. 5 is a flow chart depicting mains steps of methods of wireless communication for supporting and performing a handover, according to an embodiment.

FIG. 6 is a flow chart depicting mains steps of methods of wireless communication for supporting and performing a handover, according to an embodiment.

FIG. 7 is a block diagram of an apparatus arranged to implement a method of wireless communication for supporting a handover by a user equipment.

FIG. 8 is a block diagram of an apparatus arranged to implement a method of wireless communication for performing a handover by a target base station.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention. Also, it should be understood that, although the present disclosure is exemplified with respect to a non-terrestrial base station, this should not be seen as limiting the scope of the invention, as the teaching of the present disclosure could be applied to terrestrial base stations without modifying the invention.

FIG. 1 shows an exemplary 5G New Radio (NR) wireless communication system 100 configured to support a handover procedure in a non-terrestrial network (NTN) in accordance with an embodiment of the disclosure.

The wireless system 100 comprises at least a first NTN base station 101 and a second NTN base station 102. In the example of FIG. 1, NTN base stations 101 and 102 are LEO satellites orbiting around the earth with known/or predictable orbital parameters. However, it is to be noted that base stations 101 and 102 could be of any High-Altitude Platforms Systems (HAPS) including airplanes, balloons, or airships, or event terrestrial base stations. In some example, NTN base stations 101 and 102 are 5G NR base stations (gNodeB, or gNB).

FIG. 1 also shows a first User Equipment (UE) device 105 and a second User Equipment device 106, initially served in a source cell by base station 101. UE 105 and UE 106 may be of any type. For example, UE 105 may be a mobile phone, a connected vehicle or IoT device (Internet of Things). UE 106 may also be a mobile phone, a connected vehicle or IoT device.

LEO satellites 101 and 102 are traveling along a predictable orbit at a constant speed relative to the earth's ground, for example at 7.56 km/s, thus making their respective radio beams 103 and 104 moving over time. UE 105, as well as other UE served in the same cell like UE 106, is therefore frequently handed over to a new target cell. Considering the large cell size of NTN, a potentially very large number of UEs may thus need to perform handover at the same time.

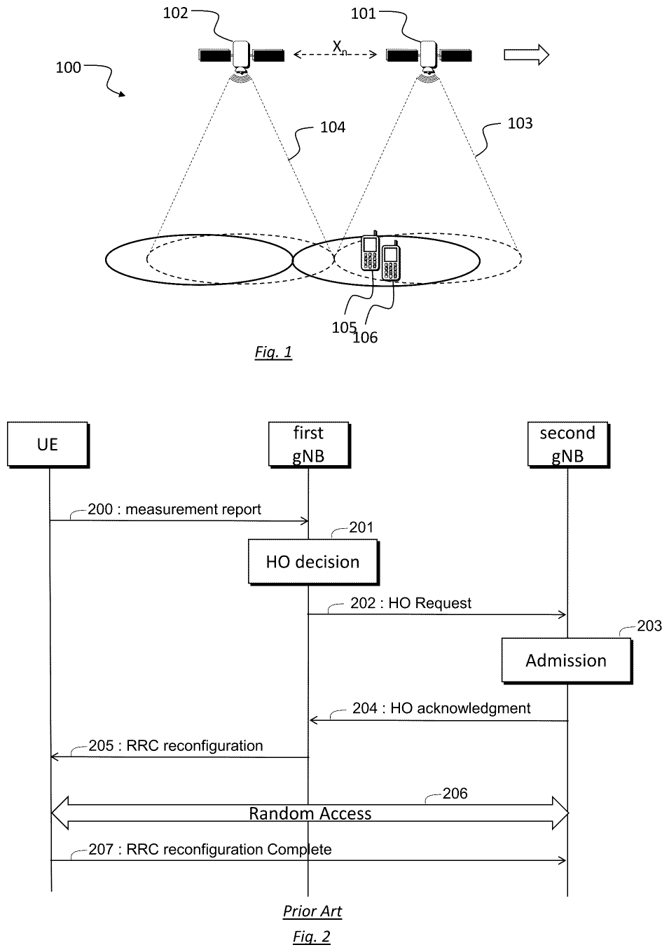

FIG. 2 is a call flow illustrating a traditional inter-cell state of art handover procedure. UE periodically transmits measurement reports regarding signal quality in a message 200. Source gNB takes a decision 201 to handover UE when signal strength from target gNB becomes greater than signal strength from source gNB and sends a handover request 202 to a target gNB through inter-gNB Xn interface. Target gNB acknowledge the handover request in a message 204 transmitted to the source gNB after an admission check 203. Source gNB then sends a handover command 205 (i.e., RRC reconfiguration message) to the UE to instruct UE to switch to the target gNB.

Upon reception of said handover command 205, UE synchronizes with target gNB and performs a random access procedure 206 to establish communication channels before sending a handover complete message 207 (i.e., RRC reconfigurationComplete message).

UE initiates such a random access procedure by randomly selecting a signature from a given set of signatures, and by transmitting a so-called preamble containing the selected signature to the target gNB. This preamble is also referred to as a “random access preamble”.

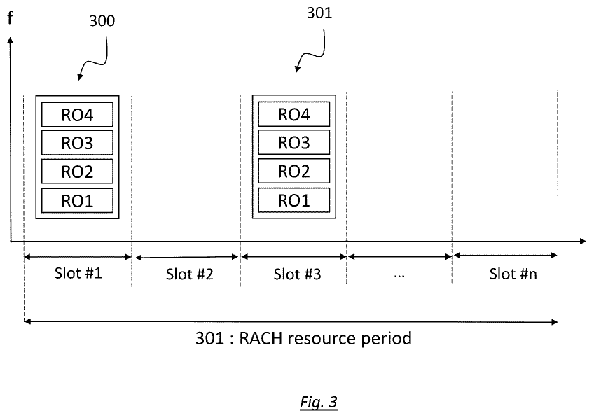

Preamble transmission can take place within a configurable subset of periodical RACH slots within a cell. The amount of resources for the Physical Random Access Channel (PRACH) may be configured depending on cell characteristics: if the cell is large, like in NTN systems, many upload requests may be issued due to large number of users whereas for small, the amount of resources could be limited. As shown on FIG. 3, the resource for PRACH may be set in both time (t) and frequency (f). Timing part indicates how often it is occurring in upload and the frequency part indicates how wide the resources are. RACH periodicity can be set between 10 and 160 ms and this value indicates how often this pattern with resources is repeated (RACH Slot). Within each RACH Slot, there can be number of RACH occasions which specifies the number of different that are available for each slot. FIG. 3 shows an exemplary RACH configuration comprising a first set of RACH occasions 300 in slot #1, a second set of RACH occasions 301 in slot #3 within a RACH period 302 comprising N slots. The sequence of RACH slots #1 to #N is thus repeated within each successive RACH periods. In the example of FIG. 3, each RACH slot comprises four RACH occasions R1-R4.

Since different UEs can start a random access procedure on the common RACH channel at the same time, and because only a limited number of different signatures is available for selection, different UEs may randomly select the same signature. If this happens, the unique identification of the respective UE and the messages coming from it or to it in the synchronization process is hindered by so called collisions. Therefore, the Random Access procedure may fail, resulting in a termination of the Random Access procedure, the UE must repeat the random access procedure at a later time.

It is easily understood that the risk of such collisions occurring is particularly high when a large number of UEs are transferred from a source gNB to a target gNB at the same time.

It is therefore an object of the present disclosure to propose a method for limiting the risk of collision.

To achieve this goal, it is proposed an inventive method wherein at least one particular RACH slot or RACH occasion is assigned to a user equipment depending on its quality of service profile. Such a provision allows UE with different profile to user distinct RACH slots/occasion, thus avoiding contention during random access. These particular RACH slots/occasions may be selected among a full set of RACH occasions available for synchronizing with a target UE.

According to an embodiment, the selection may be performed by target base station 101.

According to an embodiment, the selection may be performed by serving base station 102.

In some embodiments, the selection of US-specific RACH slots/occasion may be performed by user equipment 105.

For the sake of clarity, a same reference designates a same entity across the following description.

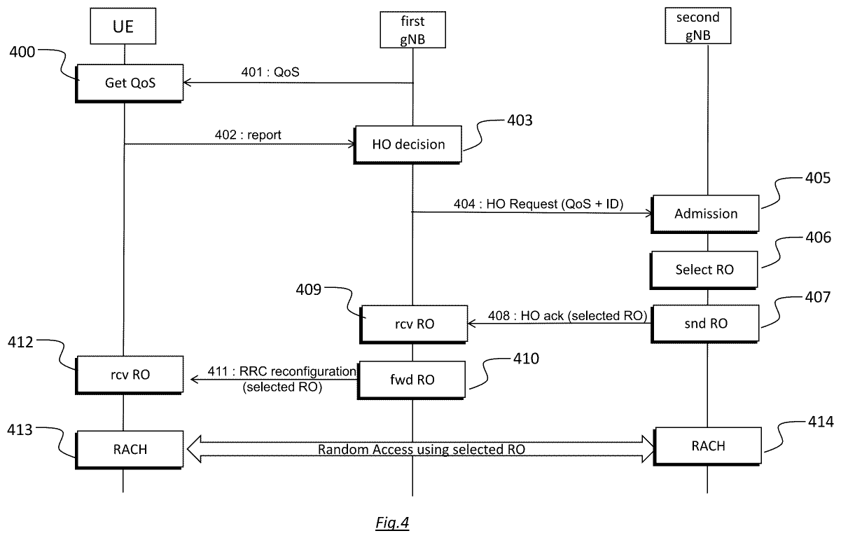

A first embodiment of the disclosure will now be described with reference to FIG. 4.

FIG. 4 is a combined flow chart and block diagram illustrating main steps of the disclosed methods for handing over a user equipment 105 from a first base station 101 to a second base station 102 within a wireless network, according to an embodiment.

User equipment 105 is assigned a particular QoS profile by the first base station 101 during a first step 400. In some embodiment, said QoS profile may be received in a RRC message 401 sent by the base station 101 serving the cell within UE 105 is located. The received QoS profile may comprise one or more 5QI values, CQI values, a priority value, or a specific flag. Thus, both UE 105 and base station 101 knows the QoS profile associated with UE 105.

UE 105 may send periodic or aperiodic measurement reports 402 including quality values of signals it receives from base stations 101 and 102. Based on these measurement reports, the first base station 101 may take a decision of handover decision at step 403. For example, base station 101 may take a handover decision when measurement reports sent by UE 105 indicates that second base station 102 offers a better radio signal quality than the serving base station 101.

This decision triggers the sending of a handover request 404 to the second base station 102, said handover request comprising at least a QoS profile assigned to UE 105 at step 400. The handover request 404 may be sent to base station 102 through Xn interface.

The second base station 102 receives the handover request 404 during a step 405 and performs admission control and determines a set of RACH slots and/or RACH occasions available for a user equipment to achieve uplink channel synchronization to base station 102.

During step 406, base station 102 selects a user equipment-specific subset of RACH slots or RACH occasions from the set of RACH slots or RACH occasions determined at step 405, said subset being determined according to at least a characteristic of UE 105 received in handover request 404. More specifically, base station 102 may determine said UE-specific subset of RACH slots/occasions according to the QoS profile assigned to UE 105.

In some embodiment, base station 102 uses a preconfigured mapping table containing association between some RACH slots or occasions and particular QoS profiles to select RACH slots/occasions according to UE 105's QoS profile.

According to an embodiment, base station 102 may assign RACH occasions to a particular UE dynamically, depending on a context. For example, the target base station 102 may consider its current load, i.e., current usage of available radio resources, for assigning RACH slots to UE 105. For example, the target base station 102 may choose to assign a “later” RACH slot/occasion to a new UE until another UE has left or resource allocation was adapted for “onboarding”/accommodating the new UE, i.e., previously occupied radio resources become available for serving the new UE.

In some examples, the number of RACH occasions selected for a high QoS UE may be greater than the number of RACH occasions selected with low QoS UE, resulting in less collisions occurring for high QoS UE.

The base station 102 may reserve particular RACH slots and/or RACH occasions to specific UE QoS profiles (e.g., 5QI values). For example, base station 102 may assign a first set of RACH occasions to UEs associated with a first QoS profile and a second set of RACH occasions to UEs associated with a second QoS profile.

At step 407, base station 102 sends a handover acknowledgment message 408 to base station 101 said message 408 comprising said subset of RACH slots/occasions selected for UE 105 at step 406.

At step 409, the first base station 101 receives said message 408 comprising the subset of RACH slots/occasions selected by base station 102 for UE 105.

At step 410, base station 101 may forward to UE 105 the specific subset of RACH slots/occasions received in message 408. Base station 101 may forward said subset of RACH occasions using a handover command message 411, e.g. in a RRC reconfiguration message.

During a step 412, user equipment 105 may receive the message 411 from the first base station 101. The received message includes at least a UE 105-specific subset of RACH slots/occasions selected among available RACH slots/occasion for a UE to perform RACH to the second base station 102. The subset is selected from the set of available RACH occasions according to said QoS profile assigned to UE 105 during step 406.

At step 413, UE 105 may initiate a random access procedure using a RACH occasion from the received UE-specific subset or RACH slots/occasions to achieve uplink synchronization to second base station 102.

At step 414, base station 102 may receive a Random Access Request from UE 105 on a RACH occasion which was associated with UE 105 QoS value during step 406.

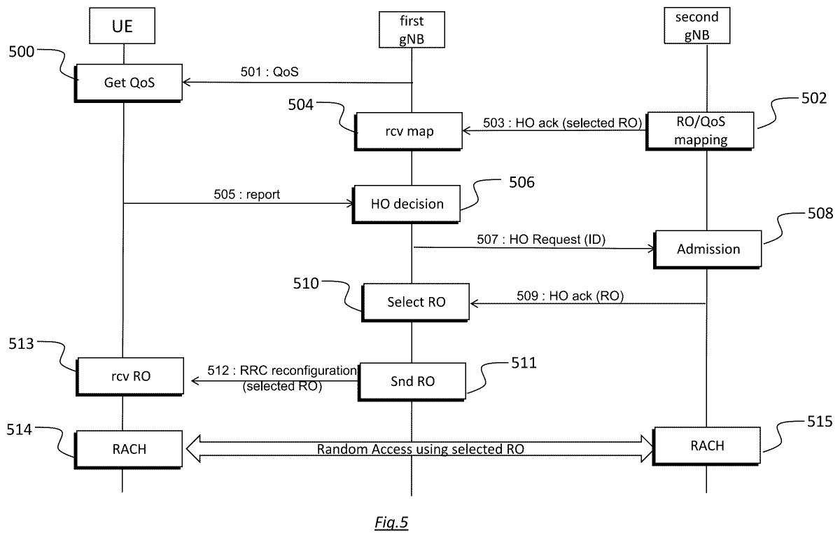

A second embodiment of the disclosure will now be described with reference to FIG. 5.

FIG. 5 is a combined flow chart and block diagram illustrating main steps of the disclosed methods for handing over a user equipment 105 from a first base station 101 to a second base station 102 within a wireless network, according to an embodiment.

User equipment 105 is assigned a particular QoS profile by the first base station 101 during a first step 500. In some embodiment, said QoS profile may be received in a RRC message 501 sent by the base station 101 serving the cell within UE 105 is located. The received QoS profile may comprise one or more 5QI values, CQI values, a priority value, or a specific flag. Thus, both UE 105 and base station 101 knows the QoS profile associated with UE 105.

Base station 102 may determine a mapping between RACH occasions or RACH slots and specific QoS profiles during a preliminary step 502. More precisely, base station 102 may determine a set of RACH slots and/or RACH occasions that are available for a UE to synchronize, then assign each of these RACH slots/occasions to a particular QoS profile. Such mapping may be a table in which RACH occasion are associated with QoS profiles. Such mapping may be updated on a periodic basis or when a particular event occurs, and transmitted to base station 102 when updated in a message 503 sent over Xn interface.

As an example, target base station 102 may consider its current load, i.e., current usage of available radio resources, for assigning RACH slots/occasions to specific QoS profiles. For example, the target base station 102 may choose to assign a “later” RACH slot/occasion to low QoS profiles. In some other example, base station 102 may assign a first set of RACH occasions to a first QoS profile and a second set of RACH occasions to a second QoS profile, the first set of RACH occasions comprising a greater number of RACH slots or occasions than the second one.

At step 504, base station 101 receives the RACH occasions/Qos mapping table determined by base station 102 and stores it in a memory.

UE 105 may send periodic or aperiodic measurement reports 505 including quality values of signals it receives from base stations 101 and 102. Based on these measurement reports, the first base station 101 may take a decision of handover decision at step 506. For example, base station 101 may take a handover decision when measurement reports sent by UE 105 indicates that second base station 102 offers a better radio signal quality than the serving base station 101.

This decision triggers the sending of a handover request 507 to the second base station 102.

The second base station 102 receives the handover request 404 during a step 508 and performs admission control. In some embodiments, base station 102 may update the mapping determined at step 502 if required, e.g., depending on its current load and/or radio resource usage, and send the updated mapping to base station 101 in a dedicated message or, for example, in a handover acknowledgement message 509.

Once admission of UE 105 is approved by base station 102, a handover acknowledgement message 509 may be issued to base station 101, comprising a set of available RACH occasions available for performing random access.

The receiving of the message 509 may trigger a step 510 during which base station 101 may select, within the set of RACH occasions received in message 509, a subset of RACH slots/occasions corresponding to the QoS assigned to UE 105. More specifically, base station 101 uses the mapping between RACH occasions and QoS profiles received at step 504 to determine, among RACH occasions received in message 509, RACH occasions that corresponds to the QoS profile assigned to UE 105.

In some embodiment, base station 101 may use a preconfigured mapping table containing association between some RACH slots or occasions and particular QoS profiles to select RACH slots/occasions according to UE 105's QoS profile.

At step 511, base station 101 may send to UE 105 the selected subset of RACH slots/occasions determined at step 510 in a handover command message 512, e.g. in a RRC reconfiguration message.

During a step 513, user equipment 105 may receive the message 512 from the first base station 101. The received message includes at least a UE 105-specific subset of RACH slots/occasions selected among available RACH slots/occasion for a UE to perform RACH to the second base station 102. The subset is selected from the set of available RACH occasions according to said QoS profile assigned to UE 105 during step 510.

At step 514, UE 105 may initiate a random access procedure using a RACH occasion from the received UE-specific subset or RACH slots/occasions to achieve uplink synchronization to second base station 102.

At step 515, base station 102 may receive a Random Access Request from UE 105 on a RACH occasion which was associated with UE 105 QoS value during step 406.

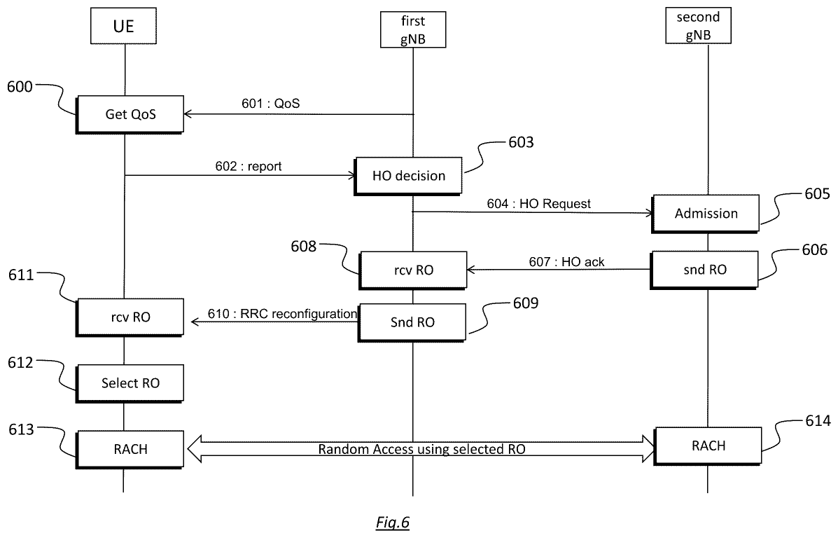

A third embodiment of the disclosure will now be described with reference to FIG. 6.

FIG. 6 is a combined flow chart and block diagram illustrating main steps of the disclosed methods for handing over a user equipment 105 from a first base station 101 to a second base station 102 within a wireless network, according to an embodiment.

User equipment 105 is assigned a particular QoS profile by the first base station 101 during a first step 400. In some embodiment, said QoS profile may be received in a RRC message 601 sent by the base station 101 serving the cell within UE 105 is located. The received QoS profile may comprise one or more 5QI values, CQI values, a priority value, or a specific flag. Thus, both UE 105 and base station 101 knows the QoS profile assigned to UE 105.

UE 105 may send periodic or aperiodic measurement reports 602 including quality values of signals it receives from base stations 101 and 102. Based on these measurement reports, the first base station 101 may take a decision of handover decision at step 603. For example, base station 101 may take a handover decision when measurement reports sent by UE 105 indicates that second base station 102 offers a better radio signal quality than the serving base station 101.

This decision triggers the sending of a handover request 604 to the second base station 102. The handover request 604 may be sent to base station 102 through Xn interface.

The second base station 102 receives the handover request 604 during a step 605 and performs admission control and determines a set of RACH slots and/or RACH occasions available for a user equipment to achieve uplink channel synchronization to base station 102.

During step 606, base station 102 sends to the base station 101 a handover acknowledgement comprising RACH slots and/or RACH occasions determined at step 405.

At step 609, base station 101 may forward to UE 105 the set of RACH slots/occasions received in message 607. Base station 101 may forward said subset of RACH occasions using a handover command message 610, e.g. in a RRC reconfiguration message.

UE 105 receives the set of RACH slots/occasion during a step 611. UE 105 thus receives a message from the first base station 101, said message comprising a set of RACH occasions available for UE 105 to perform random access to base station 102. It is contemplated that said message may be a handover command message, e.g., a RRC Reconfiguration Request message sent by the first base station 101 in which at least one RACH occasion is provided.

During step 612, base station 102 selects a user equipment-specific subset of RACH slots or RACH occasions from the set of RACH slots or RACH occasions received at step 611, said subset being determined according to at least a characteristic of UE 105. In some examples, the subset of RACH slots/occasion is selected according to a QoS profile assigned to UE 105.

In some embodiment, UE 105 may use a preconfigured mapping table containing association between some RACH slots or occasions and particular QoS profiles to select RACH slots/occasions according to UE 105's QoS profile. Said mapping table may be provisioned by the network of preconfigured in a firmware of UE 105. According to an embodiment, said mapping table may assign a number of RACH slots/occasions within a RACH period depending on a QoS profile. In some examples, the number of RACH occasions associated with high QoS UEs may be greater than the number of RACH occasions associated with low QoS UEs.

UE 105 may select a particular RACH slot and/or occasion within the received RACH slots/occasions by looking up its assigned QoS profile in the mapping table and selecting RACH slots/occasions corresponding to said QoS profile. The subset is thus selected from the set of available RACH occasions according to said QoS profile assigned to UE 105 during step 600. This way, US 105 may obtain a UE-specific subset of RACH slots/occasions selected among available RACH slots/occasion to perform RACH to the second base station 102.

At step 613, UE 105 may initiate a random access procedure using a RACH occasion from the received UE-specific subset or RACH slots/occasions to achieve uplink synchronization to second base station 102.

At step 614, base station 102 may receive a Random Access Request from UE 105 on a RACH occasion which was associated with UE 105 QoS value during step 600.

It could be appreciated that UE with different QoS profile will thus receive different RACH occasions within the handover command message, making it possible to, therefore limiting occurrence of contention when a large number of UE is handed over.

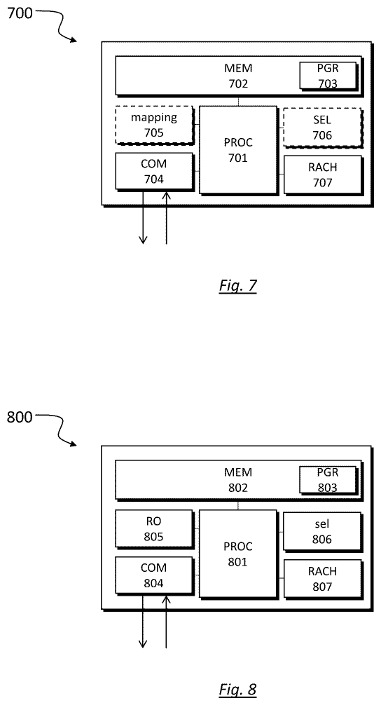

FIG. 7 is a block diagram showing a schematic architecture of an apparatus 700 suitable to implement a method of wireless communication for supporting a handover by a user equipment device, from a first base station to a second base station, according to an embodiment.

The apparatus 700 comprises a processor 701 and a memory 702, for example a Random Access Memory (RAM). The processor 701 may be controlled by a computer program 703 stored in the memory 702 comprising instructions configured to implement a method of wireless communication for supporting a handover, according to a particular embodiment.

More precisely, the computer program 803 comprises instructions for performing a random access procedure to a second base station using a Random Access CHannel occasion (RACH Occasion, or RO) selected from a set of Random Access CHannel occasions according to a QoS profile assigned to said user equipment.

On initialization, instructions of the computer program 703 may be loaded into the memory 702 before being executed by the processor 701. The processor 701 implements the steps of the method according to the instructions of the computer program 703.

The apparatus 700 comprises a wireless communication unit 704, for example a 3G, 4G, 5G, 5G NR, WiFi or WiMax transceiver for exchanging messages with other apparatus. In particular, communication unit 704 is configured to synchronize and exchange data with a base station of a wireless access network, for example a NodeB (NB), eNodeB (eNB) or gNodeB (gNB).

The communication unit 704 may be further configured by computed program instructions to receive at least one QoS profile transmitted by the first base station. For example, the communication unit may be arranged to receive a RRC message transmitted by the first base station and to extract from said message at least a QCI or 5QI value defining a QoS profile of said apparatus 700.

In an embodiment, the communication unit 704 may be configured to receive a subset of RACH occasions selected by a base station according to a QoS profile assigned to said apparatus 700.

According to an embodiment, the apparatus may comprise a mapping unit 705 including a pre-configured mapping table comprising associations between some RACH slots/occasions and specific QoS profiles. Said pre-configured mapping may be provisioned by a network node upon apparatus initialization or embedded in a firmware. The apparatus 700 may further comprise a selection unit 706. Said selection unit 706 may be implemented by computer program instructions arranged to perform the selection of at least one RACH occasion and/or RACH slot by using the mapping unit 705 to look up a particular RACH occasion according to said QoS value received by communication unit 704.

In some embodiments, the apparatus 700 may also comprise a RACH module 707. The RACH module 707 may be implemented by computer program instructions arranged to perform a random access procedure to establish an uplink communication channel to the second base station using a RACH occasion selected by the selection unit 706.

In some embodiments, the apparatus 700 is integrated in a user equipment device, for example a mobile phone, a telecommunication unit of a connected vehicle, or any IoT (Internet of Things) device.

FIG. 8 is a block diagram showing a schematic architecture of an apparatus 800 suitable to implement a method of wireless communication for performing a handover of a user equipment device, from a first base station to a second base station, according to an embodiment.

The apparatus 800 comprises a processor 801 and a memory 802, for example a Random Access Memory (RAM). The processor 801 may be controlled by a computer program 803 stored in the memory 802 comprising instructions configured to implement a method of wireless communication for performing a handover, according to a particular embodiment.

More precisely, the computer program 803 comprises instructions to implement the following acts:
Obtaining a set of Random Access Channel occasions available for performing Random Access to said second base station,
Obtaining a Quality of Service profile assigned to said user equipment,
Selecting a specific subset of Random Access Channel occasions from said set of Random Access CHannel occasions obtained, said subset being selected according to at least said Quality Of Service (QOS) assigned to said user equipment,
Transmitting to the first base station, a message comprising said selected subset of random access channel occasions,
Receiving a Random Access Request from a user equipment associated with a particular QoS value, said Random Access Request being received on a RACH occasion associated with said user equipment QoS value in the determined mapping table.

On initialization, instructions of the computer program 803 may be loaded into the memory 802 before being executed by the processor 801. The processor 801 implements the steps of the method according to the instructions of the computer program 803.

The apparatus 800 comprises a wireless communication unit 804, for example a 3G, 4G, 5G, 5G NR, WiFi or WiMax transceiver for exchanging messages with other apparatus. In particular, communication unit 804 is configured to exchange data with a first base station through Xn interface. In particular, communication unit 804 is configured to receive a handover request message from a base station through Xn interface.

The apparatus 800 further comprises a RACH occasions determination unit 805. The RACH occasions determination unit may be implemented using computed program instructions arranged to determine a set of RACH occasions in frequency and time domain that are available for UE to perform uplink synchronization. RACH occasions may be determined depending on several factors, for example depending on the cell size (more RACH occasions may be configured for a large cell, and a limited number of RACH occasions may be configured for small cell size).

The apparatus 800 also comprise a RACH occasions selection unit 806. The RACH occasion selection unit may be implemented using computer program instructions arranged to associate some RACH occasions determined by unit 805 with specific QoS profiles, like 5QI values. The RACH occasions selection unit may be further configured to select one or more RACH slots/occasions according to a QoS profile of said user equipment received by the communication unit 804. In some examples, the number of RACH occasions selected for a high QoS user equipment may be greater than the number of RACH occasions selected for a low QoS user equipment, resulting in less collisions occurring for high priority UE.

The wireless communication unit 804 may be further arranged to send a handover acknowledgment message to the first base station, said message comprising at least selected RACH slots/occasions determined by the selection unit 806.

The apparatus 800 further comprises a random access unit 807 arranged to receive a RACH request from a user equipment associated with a particular QoS value, said Random Access Request being received on a RACH occasion which is associated with said user equipment QoS value in the determined mapping table.

In some embodiments, the apparatus 800 is included in a base station of a wireless access network, for example a NodeB (NB), eNodeB (eNB) or gNodeB (gNB).

1. A method of wireless communication by a user equipment for supporting a handover of said user equipment from a first base station to a second base station in a wireless network, wherein said user equipment performs random access to said second base station using a Random Access CHannel occasion from a subset selected from a set of Random Access CHannel occasions according to a Quality of Service profile assigned to said user equipment.

2. A method according to claim 1 wherein said Random Access CHannel occasion used to perform random access is selected by said user equipment from a mapping between Random Access CHannel occasions and QoS profiles.

3. A method according to claim 2 wherein said mapping between Random Access CHannel occasions and Quality of Service profiles is preconfigured in said user equipment.

4. A method according to claim 1 wherein said subset of Random Access CHannel occasions selected from a set of Random Access CHannel occasions according to a Quality Of Service profile assigned to said UE is received in a handover command message sent by said first base station.

5. A wireless communication apparatus for supporting a handover of a user equipment from a first base station to a second base station in a wireless network, said apparatus comprising a processor coupled with a memory in which computer program instructions are stored, said instructions being arranged to implement a method of wireless communication by said user performing random access to said second base station using a Random Access CHannel occasion from a subset selected from a set of Random Access CHannel occasions according to a Quality of Service profile assigned to said user equipment.

6. A user equipment comprising, a wireless communication apparatus for supporting a handover of a user equipment from a first base station to a second base station in a wireless network, said apparatus comprising a processor coupled with a memory in which computer program instructions are stored, said instructions being arranged to implement wireless communication by said user performing random access to said second base station using a Random Access CHannel occasion from a subset selected from a set of Random Access CHannel occasions according to a Quality of Service profile assigned to said user equipment.

7. A method of wireless communication by a second base station for performing a handover of a user equipment from a first base station to said second base station in a wireless network, the method comprising the following acts:
Obtaining a set of Random Access Channel occasions available for performing Random Access to said second base stations Obtaining a Quality of Service profile assigned to said user equipment;
Selecting a specific subset of Random Access Channel occasions from said set of Random Access CHannel occasions obtained, said subset being selected according to at least said Quality Of Service assigned to said user equipment;
Transmitting to the first base station, a message comprising said selected subset of random access channel occasions;
Receiving a Random Access Request from a user equipment associated with a particular QoS value, said Random Access Request being received on a RACH occasion associated with said user equipment QoS value in the determined mapping table.

8. The method according to claim 7 wherein said Quality Of Service assigned to user equipment is obtained in a handover request message received from the first base station.

9. A wireless communication apparatus for performing a handover of a user equipment from a first base station to a second base station in a wireless network, said apparatus comprising a processor coupled with a memory in which computer program instructions are stored, said instructions being arranged to implement a method of wireless-communication, operations by a second base station for performing a handover of a user equipment from a first base station to said second base station in a wireless network, the operations comprising:
Obtaining a set of Random Access Channel occasions available for performing Random Access to said second base station;
Obtaining a Quality of Service profile assigned to said user equipment;
Selecting a specific subset of Random Access Channel occasions from said set of Random Access CHannel occasions obtained, said subset being selected according to at least said Quality Of Service (QoS) assigned to said user equipment;
Transmitting to the first base station, a message comprising said selected subset of random access channel occasions;
Receiving a Random Access Request from a user equipment associated with a particular QoS value, said Random Access Request being received on a RACH occasion associated with said user equipment QoS value in the determined mapping table.

10. A base station device comprising, a wireless communication apparatus for performing a handover of a user equipment from a first base station to a second base station in a wireless network, said apparatus comprising a processor coupled with a memory in which computer program instructions are stored, said instructions being arranged to implement wireless-communication operations by a second base station for performing a handover of a user equipment from a first base station to said second base station in a wireless network, the operations comprising:
Obtaining a set of Random Access Channel occasions available for performing Random Access to said second base station;
Obtaining a Quality of Service profile assigned to said user equipment;
Selecting a specific subset of Random Access Channel occasions from said set of Random Access CHannel occasions obtained, said subset being selected according to at least said Quality Of Service (QoS) assigned to said user equipment;
Transmitting to the first base station, a message comprising said selected subset of random access channel occasions;
Receiving a Random Access Request from a user equipment associated with a particular QoS value said Random Access Request being received on a RACH occasion associated with said user equipment QoS value in the determined mapping table.

11. A wireless communication system for performing a handover of a user equipment from a first base station to a second base station in a wireless network, wherein said user equipment performs random access to said second base station using a Random Access CHannel occasion from a subset selected from a set of Random Access CHannel occasions according to a Quality of Service profile assigned to said user equipment, and wherein said second base station receives a Random Access Request on a Random Access Channel occasion selected.

12. The wireless communication system of claim 11 wherein said selected Random Access Channel occasion is selected by said second base station and wherein said Quality of Service profile assigned to said user equipment is received from said first base station in a handover request message.

13. The wireless communication system of claim 11 wherein said selected Random Access Channel occasion is selected by said first base station from a set of Random Access Channel occasions received from said second base station in a handover acknowledgment message, and wherein said selected Random Access Channel occasion is send to said user equipment in a RRC Reconfiguration message.
